(19) United States
(12) Patent Application Publication
(10) Pub. No.: US 2006/0181510 A1
(43) Pub. Date: Aug. 17, 2006

(54) User control of a hand-held device

(75) Inventor: Joe Faith, Newcastle (GB)

Correspondence Address: VENABLE LLP, P.O. BOX 34385, WASHINGTON, DC, 20045-9998, US

(73) Assignee: University of Northumbria at Newcastle, New Castle Upon Tyne (GB)

(21) Appl. No.: 11/356,241

(22) Filed: Feb. 17, 2006

(30) Foreign Application Priority Data
Feb. 17, 2005 (GB) 0503253.7

(51) Int. Cl. G09G 5/08

(52) U.S. Cl. 345/158

(57) ABSTRACT

A hand-held device (10), comprising a computing application of the hand-held device which responds to directional commands of a user; an image registering unit to register a series of images; an image processing unit (162) to derive motion data from the series of images corresponding to translational and/or rotational movement of the hand-held device in free space; and a direction control unit (164) to convert the motion data into a directional command and to supply the directional command to the computing application.

The present invention relates in general to a hand-held device and to a method of controlling the hand-held device.

Hand-held devices are available in many different shapes and sizes and for many different functions. Examples include mobile electronic games consoles, personal music players and personal digital assistance (PDAs), as well as communication-oriented devices such as cellular telephones. These hand-held devices typically contain computing applications requiring directional input from a user to control the movement of cursors, pointers, elements in games, the scrolling of a display screen or navigation through a menu structure. A directional command is supplied through a keypad, thumbwheel, touchpad, joystick or similar manipulable input. Typically these manipulable inputs are finger operated and can be difficult to use, particularly when the hand-held device is itself relatively small. The manipulable inputs tend to require relatively fine and accurate control by the user and sometimes operations become frustratingly difficult.

It is often desired to operate the hand-held device independently in free space. This restricts the use of other known devices for providing a directional input, such as a mouse or trackball, which rely on a desk or other fixed operating surface.

One aim of the present invention is to provide a hand-held device, and a method of controlling the same, which is simple and intuitive for a user to operate. A preferred aim is to avoid or reduce the use of manipulable inputs such as a keypad. Another preferred aim is to reduce the level of user dexterity required to operate the device.

Other aims and advantages of the invention will be discussed below or will be apparent from the following description.

According to the present invention there is provided an apparatus and method as set forth in the appended claims. Preferred features of the invention will be apparent from the dependent claims, and the description which follows.

Briefly, the present invention provides a hand-held device which carries an image receptor such as a camera. Images captured by the image receptor are processed to determine directional movements of the hand-held device. The detected movement is then used to control an operation or output of the hand-held device.

In a first aspect of the present invention there is provided a hand-held device, comprising: a computing application of the hand-held device which responds to directional commands of a user; an image registering unit to register a series of images; an image processing unit to derive motion data from the series of images corresponding to translational and/or rotational movement of the hand-held device in free space; and a direction control unit to convert the motion data into a directional command and to supply the directional command to the computing application.

For a better understanding of the invention, and to show how embodiments of the same may be carried into effect, reference will now be made, by way of example, to the accompanying diagrammatic drawings in which:

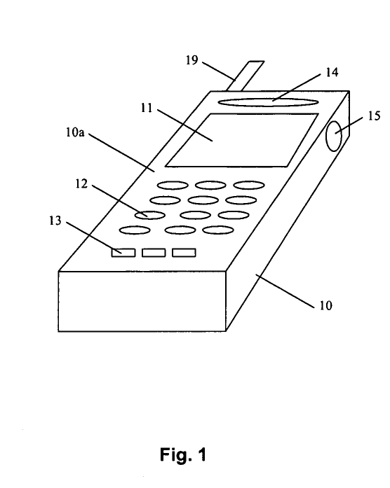

FIG. 1 is a perspective view of a hand-held device as employed in a preferred embodiment of the present invention;

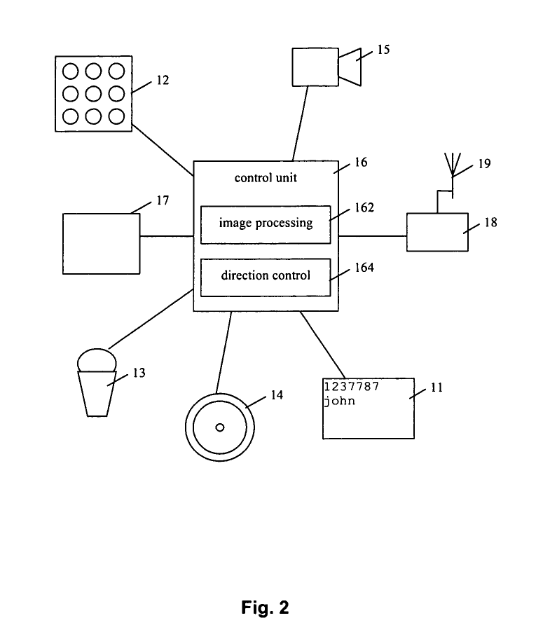

FIG. 2 is a schematic overview of the hand-held device of a preferred embodiment of the present invention;

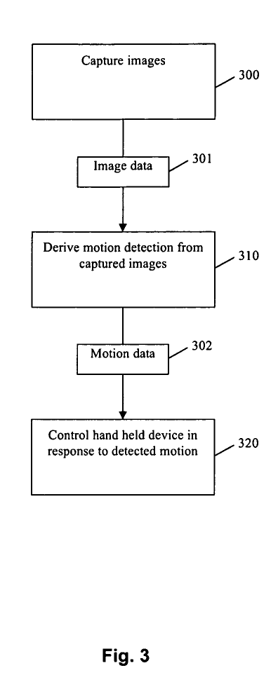

FIG. 3 is a schematic overview of a method for controlling a hand-held device, according to a preferred embodiment of the present invention;

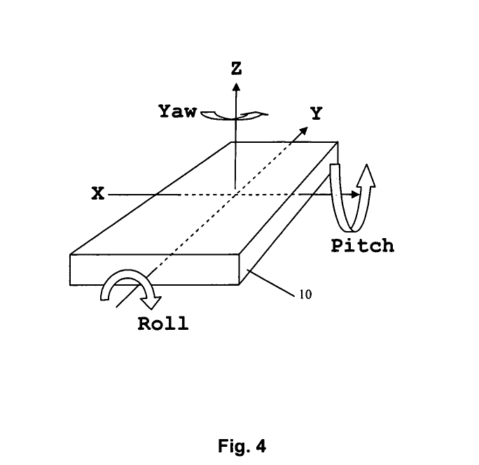

FIG. 4 is a schematic illustration of a hand-held device showing example movement directions;

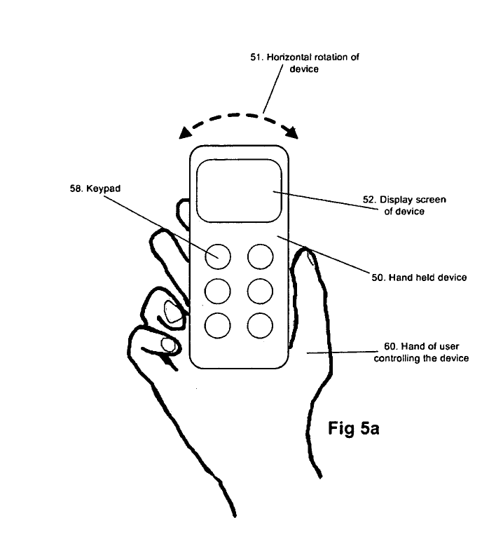

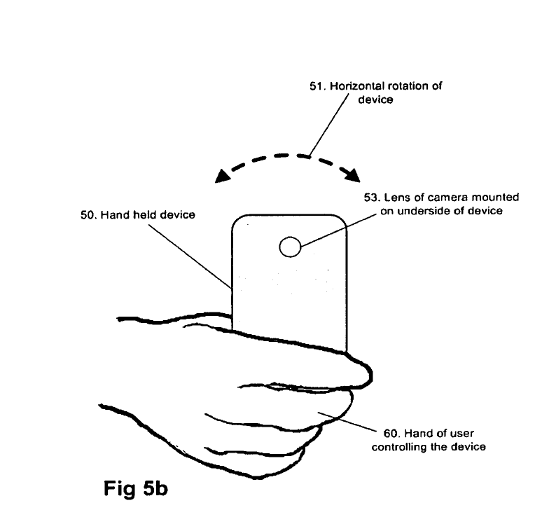

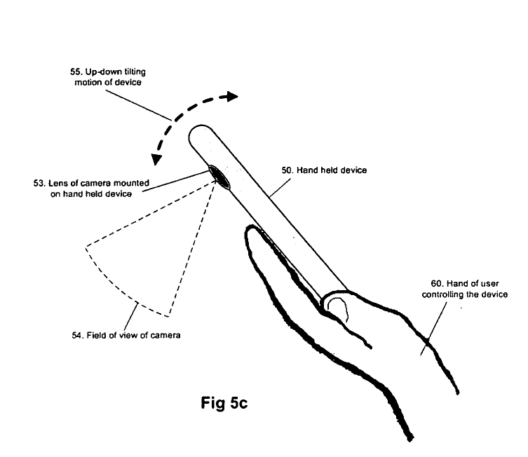

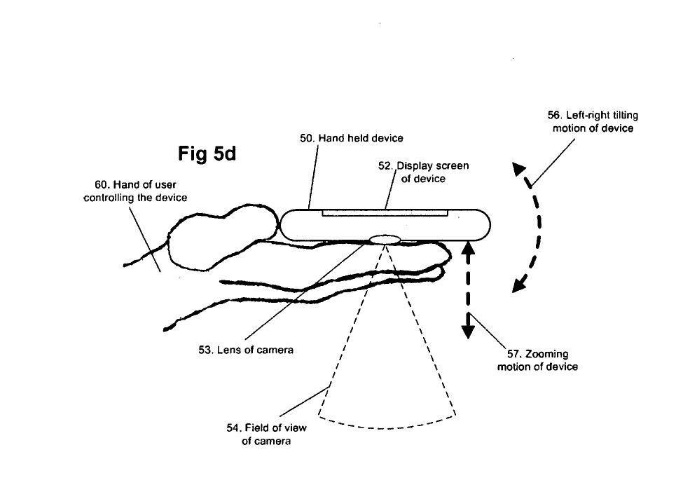

FIGS. 5a, 5b 5c and 5d are perspective views to illustrate example implementations of the preferred embodiment of the present invention;

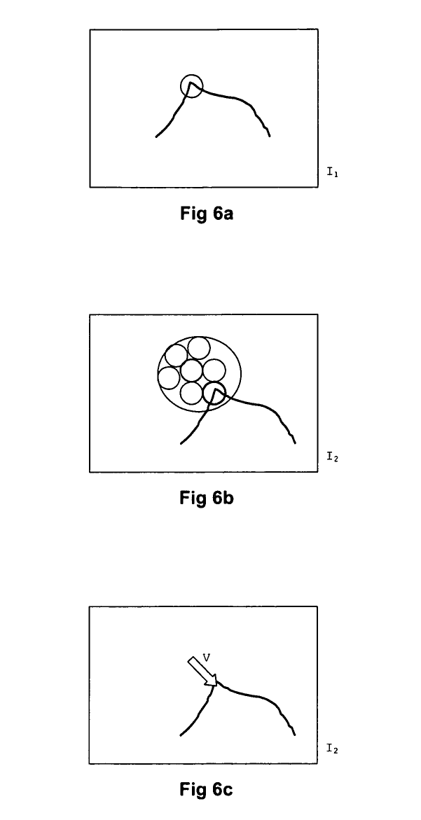

FIGS. 6a, 6c and 6c illustrate a first example 2D image processing algorithm;

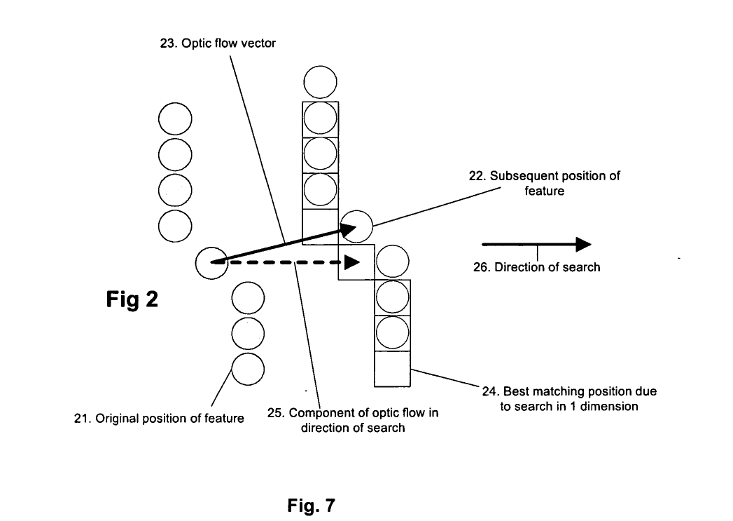

FIG. 7 shows an example 1D image processing algorithm;

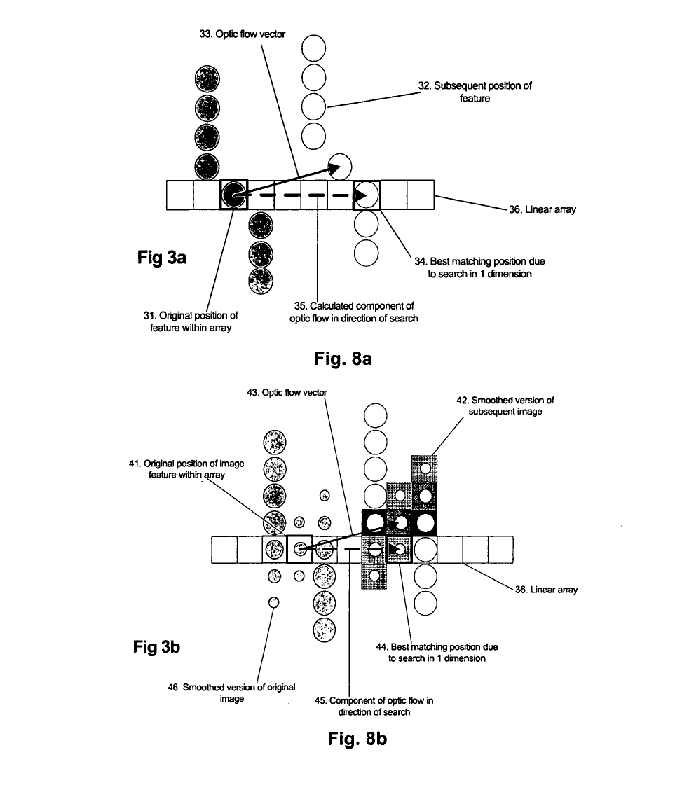

FIGS. 8a and 8b illustrate a preferred example image processing operation using a linear array;

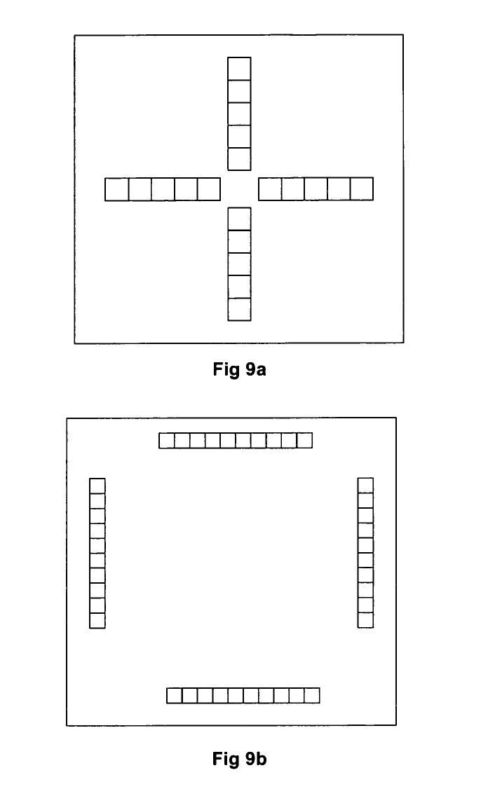

FIGS. 9a and 9b illustrate example layouts of linear arrays over an image field; and

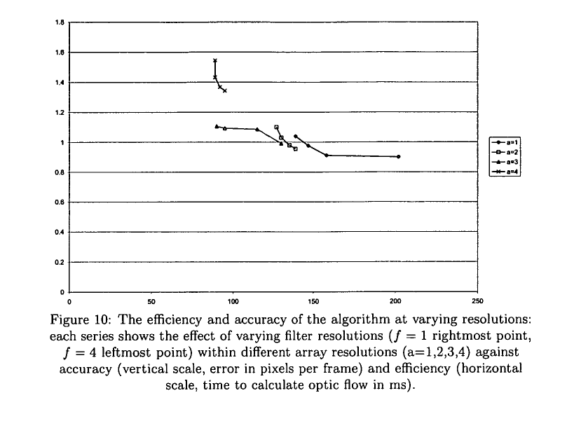

FIG. 10 shows a graph of the efficiency and accuracy of an algorithm at varying resolutions: each series shows the effect of varying filter resolutions (f=1 rightmost point, f=4 leftmost point) within different array resolutions (a=1, 2, 3, 4) against accuracy (vertical scale, error in pixels per frame) and efficiency (horizontal scale, time to calculate optic flow in MS).

Referring to FIG. 1, a hand-held device 10 is shown according to a preferred embodiment of the present invention. In this example the hand-held device 10 is a communicator device such as a GSM cellular telephone.

The hand-held device 10 includes a display screen 11 and one or more user input keys or other manipulable inputs 12. Further, the hand-held device 10 carries an image receptor 15 such as a camera. In one embodiment the camera 15 is integrated within the hand-held device 10. In another embodiment (not shown) the camera 15 is removably attached to the hand-held device 10, such as with a clip-on fitting. In either case, it is preferred that the camera 15 is fixedly arranged in use with respect to a main body portion 10a of the hand-held device 10, such that the camera 15 moves together with the hand-held device 10.

FIG. 2 is a schematic representation of functional elements within the hand-held device 10. A control unit 16 receives image data from the camera 15. The control unit 16 includes an image processing unit 162 which performs a motion detection algorithm to produce motion data derived from the image data. Also, the control unit 16 includes a direction control unit 164 to translate the motion data into direction data, and thereby control a function or output of the hand-held device. The control unit 16 suitably includes a processor to perform computing operations, and has access to a memory 17 for data storage.

The hand-held device 10 suitably includes a microphone or other audio input 13 and a speaker or other audio output 14 In this case a radio frequency (RF) communication unit 18 is provided having an aerial 19 for wireless communication such as using GSM standards. In other embodiments the hand-held device 10 is arranged for local communication using, for example, Bluetooth or IEEE 802.11 WLAN protocols.

FIG. 3 is a schematic overview of a preferred method of controlling the hand-held device.

Referring to FIG. 3, at step 300 a series of images are captured by the camera 15 and image data 301 is generated. These images reflect the location and position (i.e. orientation) of the hand-held device 10 with respect to its surroundings. The images can be a plurality of still images, or full motion video. In one embodiment, the camera 15 preferably supplies image data in the form of pixel values in a 2D image field.

Step 310 comprises producing motion data 302 from the image data 301. Here, the image processing unit 162 performs a motion detection algorithm to produce a motion data stream.

At step 320 the motion data 302 is supplied to the direction control unit 164 to control a function or operation of the hand-held device.

The images are preferably captured by the user holding the device 10 in free space and not closely adjacent to any particular object or surface. Ideally, the device is held in the hand at some distance from surrounding objects. Thus, the captured images represent the general surroundings of the hand-held device 10 within a building or externally. In preferred embodiments the device 10 is held between about 0.2 m and 2 m from surrounding objects. This range allows a good field of view from the camera 15 and provides the image data suitable for motion detection.

The camera 15 is fixedly carried by the device 10, such that movement of the device 10 causes images captured by the camera 15 to change. The changed image reflects the change of position of the device 10. Advantageously, the user moves the entire device 10, which requires relatively large motor movements. Most users find it much easier to make large-scale movements with larger motor muscles in their hand, arm or wrist as opposed to making very small movements with fine motor muscles in their fingers or thumb.

Controlling the hand-held device 10 using images from the camera 15 provides a more intuitive and simpler user interface, compared with traditional keypads or other manipulable inputs. The user simply moves the whole device 10 rather than clicking a particular button.

The image-derived interface of the present invention also provides a richer experience for the user than can be achieved by conventional manipulable inputs inputs. Most conventional user input techniques are restricted to translational movement in two directions (up-down and left-right). However, through suitable image signal processing by the image processing unit 162, with the present invention it is possible to distinguish three dimensions of translation (up-down, left-right and zoom-in/out) as well as three dimensions of rotation (pitch, roll and yaw). Although in practice few applications require control in all six of these dimensions of movement simultaneously, providing a combination of any two, three or more movements (such as pitch, roll and zoom) are immediately possible. Such combinations are especially useful within gaming applications, amongst others, by replacing the use of awkward and often unintuitive keypad combinations but still providing an equivalently complex user input.

FIG. 4 is a schematic illustration of a hand-held device 10 showing movement directions for X, Y and Z translations and R, P and Y rotations relative to the device.

FIGS. 5a, 5b 5c and 5d are perspective views to illustrate example implementations of the preferred embodiment of the present invention.

FIG. 5a shows a plan view of the device 10 from above, in which the user rotates the device horizontally in order to control some computing application whose output is displayed on the screen 12 of the device.

FIG. 5b shows the same device 10 and user from below, including the lens 15a of the camera 15 mounted on the underside of the device.

FIG. 5c shows a side elevation of the device 10 and user, and an up-down tilting motion, which may be used to control an up-down motion of some element of a computing application. The field of view of the camera 15 is also illustrated.

FIG. 5d shows an end elevation of the device 10 and user with two further ranges of movement: a left-right tilting motion, and a zooming motion.

In addition to the six degrees of freedom of movement, suitable processing of images derived from the camera may also provide information about the motion of the device relative to specific objects in the environment, rather than to the general background, to provide input to a computing application. For example, the measured motion of the device relative to a physical obstacle may provide useful input to a game in which an avatar's position relative to virtual obstacles provides an element of game play.

In another embodiment the device is not held in the hand but is attached in some other way to the user such that their movements, either deliberate or not, effect directional control to some computing application. In one embodiment the device is wearable or otherwise readily portable. For example, the device is worn at a user's forehead, such that changes in the direction they face are used to control a computer game.

Optic Flow

FIGS. 6, 7 & 8 illustrate preferred image processing operations employed by embodiments of the present invention.

Characteristics of the camera 15 are determined by the mobile device 10 in which this invention is embodied, while the characteristics of the output or function of a computing application depend on the particular purpose to which this invention is put. Therefore it is the characteristics and implementation of the motion detection algorithm that are discussed here in detail.

In one embodiment, the invention utilises measurements of optic flow within a series of images to determine the motion of the device 10 relative to its surroundings. Optic flow is the perceived motion of objects as the observer—in this case the camera 15—moves relative to them. For example, if the image of an object is expanding but not moving within the field of view then the observer is moving straight towards that object. This measurement would then be interpreted as a translation of the device perpendicular to the plane of the camera 15—in effect a ‘zoom-in’ command issued by the user. Similarly, a series of images dominated by a parallel left-to-right shift corresponds to a shear of the device to the users' right, parallel to the dominant background.

Given sufficiently detailed and high-quality images, a large enough field of view, and sufficient computer processing power it is possible to derive measures of all six degrees of freedom of rotation and translation of the camera 15. In addition, a measure of the time to impact, and hence relative distance from, an obstacle in the surroundings can be also be derived from the ratio between the perceived size of an object in an image and its rate of expansion.

There are many techniques available for the computation of the optic flow characteristics of a series of images, and for subsequently determining the motion of the camera. Some of these techniques involve specialised hardware, including specialised image processing hardware and specialised photoreceptor arrays. Although such devices may be employed in one possible embodiment of this invention, the preferred embodiment requires no hardware modification to the digital device 10 on which the invention is intended to operate. Instead the preferred embodiment utilises the computing resources provided by the device to perform an algorithm to compute characteristics of the optic flow.

Optic flow is mathematically expressed as a vector field in the two dimensional visual field, and typical computer vision systems compute the values of this vector field by analysing differences in series of images.

The simplest types of method for computing optic flow, known as correlation algorithms, rely on spatial search to find the displacement of features between temporally adjacent images.

FIG. 6a is a schematic view of example image features, to show a location of a feature of an image in the first frame I₁ of a series of images.

FIG. 6b shows how a correlation algorithm searches the space around that position in a subsequent frame I₂. The location of the best match in the second frame I₂ is found and the translation between the two locations determines an optic flow vector V as shown in FIG. 6c.

The process is then repeated for other features in the first image I₁ to produce a description of the optic flow vector V for some proportion of the image. If many partial match locations are found within the range of search (illustrated by a large circle in FIG. 6b), then the single best match is usually used to calculate the optic flow vector—a so-called ‘winner takes all’ algorithm. The match between an original and displaced image is typically calculated as the sum of the Euclidean distance between the values of their respective pixels, with better matches corresponding to lower differences.

Correlation algorithms are conceptually simple and robust, but computationally expensive, since they require searching a potentially large 2D space to find feature matches. A typical correlation algorithm capable of determining the complete optic flow field of an image has complexity of the order O(V²S), where S is the image size and V is the maximum motion velocity that may be detected. This complexity is a particular concern when implementing such algorithms on mobile devices that have restricted computational power, and for applications in which real-time responses to user input is required.

FIG. 7 illustrates an alternative 1D technique which can be compared against the 2-dimensional correlation algorithms of FIG. 6. This 1D technique estimates perpendicular components of the optic flow vector separately and so reduces a 2-dimensional search into two 1-dimensional searches. Instead of searching the entire, or some proportion of, the 2-dimensional image space to find a best matching displacement of an original feature, the best match is found by searching one dimension only. The component in the search direction of the true displacement can then be found. Perpendicular searches may then be combined to estimate the original magnitude and direction of the optic flow. In this way, the space to be searched is reduced from order O(SV²) to order O(2VS) while maintaining a good estimate of the flow field.

FIG. 8 shows that the technique may be further simplified by considering only the correlation within a linear 1-dimensional patch. The position of the feature within the patch in the original image I₁ is compared with the best match position in the subsequent image I₂, and the difference found (A). The use of this method reduces the complexity of the search algorithm to O(2VL), where L is the length of the array, however it is prone to errors in those situations where the detected image features are not perpendicular to the major axis of the array, as illustrated in FIG. 8a. These errors may be ameliorated by smoothing the image perpendicular to the major axis of the array, such as through use of a 1-dimensional Gaussian filter, before finding correlations between feature positions. An illustration of this smoothing is illustrated in FIG. 8b, in which both the original I₁ and subsequent I₂ images are smoothed in a direction perpendicular to the linear array. The brightness of each pixel making up a feature is represented using circles of varying sizes. Using this technique, the displacement in the direction of the linear array between the original and subsequent position of a feature is reduced.

An additional refinement to this technique of using 1-dimensional arrays is to discount changes in average lighting intensity across an image by taking first or second derivatives of the image values along the length of the array, rather than absolute values.

Such linear arrays may be combined in various configurations to provide estimates of various properties of the optic flow field and the relative motion of the camera with respect to a fixed background.

The accuracy of the relative motion of the camera can be further enhanced by combining independent estimations of the optic flow in each of the red, green and blue colour channels typically used to represent a digital image, rather than by making a single estimation of the optic flow using a grey-scale approximation of an original colour image.

FIG. 9a shows a configuration of arrays that may be used to estimate a zooming motion of the camera, or a left-right or up-down tilting motion, depending on the magnitude and sign of the measured components of motion of each array.

FIG. 9b shows a configuration of linear arrays that may be used to estimate horizontal rotation of the camera.

Thus a further refinement of this invention is to adjust the configuration of linear arrays, including the configurations shown in FIG. 9, to the requirements of the particular computing application this invention is being used to control.

Referring to FIG. 1, many hand-held devices 10 are provided with a display screen 11 prominently on an upper front surface thereof. The camera 15 tends to be located on an opposite rearward facing surface. It is desired to maintain the display screen 11 relatively stationary with respect to the viewing user. Hence, a particularly preferred embodiment of the present invention allows the user to perform a left/right linear control of the display screen 11 by rotational yaw movement of the device 10. That is, the user moves the device 10 in the yaw direction Y in order to control an X transition of images displayed on this display screen 11. This is very effective for scrolling type movements.

Example Applications

In a first preferred example, the hand-held device 10 is controlled in relation to an audio output such as through the speaker 14. In these embodiments the direction control unit 164 causes a musical output to change, allowing the user to create music through movement of the hand-held device. The created music is stored such as in memory 17 and for retrieval later such as a polyphonic ring tone.

In a second example, sound output is controlled with rising and falling pitch according to movement of the device 10 to create a “swoosh” or “light sabre” sound.

In other embodiments the device 10 is controlled to provide a textual input by a “hand writing” or “graffiti” function or a “dasher” type system.

In a third embodiment the device 10 is controlled to navigate menu structures, to scroll a display 11 in 1, 2 or 3 dimensions, or to control a movement of a graphical pointer.

Many other creative gaming and imaging effects are also applicable in relation to the present invention. For example, shaking the device creates a snow storm effect to gradually white out an image displayed on the display screen 11. Alternatively, simple 2D line drawings are created through movement of the device. Further, many games employing motion such as a “pachinko” type game controlling the motion of balls falling across a screen, or a “ball maze” type game in which a ball is guided around a maze whilst avoiding holes. Other games include surfing, snowboarding or sky diving type activities where motion of the device 10 controls the displayed motion of an avatar.

Yet further applications of the present invention control operations within the device 10. For example, a mobile telephone recognises a physically inactive state (e.g. lying on a desk) and then recognises activity (i.e. the phone has been picked up). This activity recognition can, for example, then be used to recognise that the user has picked up the phone and automatically answer an incoming voice call.

Another application is to allow a user to view an image that will not fit on a display of the device. Movement of the device can be used to scroll across the image to the left, right, or up/down. Also movement of the device towards the user or away can zoom in or out on a part of the view image. Thus the impression is given that a user is viewing as if through a moving magnifying glass or window onto the image.

A further application is the use of the motion detection to navigate web pages. In such an application the up/down motion or motion towards/away from a user (which can be used to zoom) may also activate a chosen hyperlink.

In another gaming example, movement of the device 10 is used to generate a random number or pseudo random number, such that movement of the device 10 is equivalent to shaking of dice.

The present invention has many benefits and advantages, as will be apparent from the description and explanation herein. In particular, a hand-held device is provided which is simple and intuitive for a user to operate. The image-derived control operations avoid or reduce the need for user to action a keypad or other manipulable inputs-type input. Moving substantially the whole device reduces the level of user dexterity required to operate the device. In some embodiments of the invention, this may allow people with movement difficulties, such as due to illness or injury, to better be able to operate a device.

Although a few preferred embodiments have been shown and described, it will be appreciated by those skilled in the art that various changes and modifications might be made without departing from the scope of the invention, as defined in the appended claims.

Implementation On A Mobile Device

The algorithm tested detects optic flow translation across the visual field of the image in the x and y directions independently. The optic flow detector consists of three sets (one for each colour channel) of two crossed arrays, each filtered by a 1D gaussian filter normal to the direction of the array. If the value of a cell at position i within an array at frame t is given by I_{t,color,orientation}(i), where 0≦i≦1, then the displacement, d(t), between frames in each array is that which minimises the mean absolute difference between cells at that displacement.

$${min}_{d = - v}^{v} ( \frac{{\sum }_{i = d}^{I} \vert {I}_{t} ( i ) - {I}_{t - 1} ( i - d ) \vert}{l - \vert d \vert} )$$

where v is the maximum translation velocity to be detected, measured in pixels per frame. In order to detect false positives—i.e. camera motions that do not correspond to restricted tilting—a threshold, θ, was defined for this difference: if no correlation less than the threshold were found, then the translation in that array was recorded as not matched. If all arrays for an orientation, x or y, were matched then the optic flow in each direction is calculated as the mean of the displacements within each colour channel:

$${d}_{x} = \frac{1}{3} ( {d}_{x , red} + {d}_{x , green} + {d}_{x , blue} )$$

The standard deviation and aperture of the gaussian filter were both 70% of the total available image size, and the threshold was 2% of the total available image intensity.

Note that this differs from the technique used by Golland (P Golland and A M Bruckstein, Motion from Color, Tech Report, Israel Institute of Technology, 1997). Whereas she uses a color conservation assumption (i.e. that the ratios between color remains constant) here we are making a color intensity conservation assumption (i.e. that the absolute intensity of each color channel remains constant). This latter consumption was found to yield more accurate estimates of optical flow in practice, possibly due to two reasons. First, we are interested in the small translations due to camera tilt, and the color intensity assumption is more likely to hold in these cases than for larger motions. Second, the color channels are filtered separately and, since division is not distributive over addition, the color conservation assumption does not imply that the ratios between filtered color channel values remain constant.

This algorithm was implemented in micro edition Java (J2ME) for a Mobile Information Device Profile (MIDP2.0) with Mobile Media API (JSR-135), and tested on a Nokia 7610 mobile phone with a Symbian series 60 operating system with 8 MB RAM (6 MB heap available) and a 32-bit RISC ARM9 CPU running at 123 MHz. The camera on this device captures video data at 15 frames per second at a resolution of 128×96 pixels with a field view of 53°. This implementation was chosen since it represents a common, standard, mobile platform. No attempt was made to optimise the implementation for the characteristics of the device and hence the performance of the algorithm on this platform could be reasonably expected to be similar for a wide range of similar devices.

Testing And Evaluation

This implementation was tested in two ways: for accuracy and efficiency, and for usability.

Accuracy And Efficiency

The algorithm was tested for accuracy and efficiency against a set of short video clips of various interior scenes recorded on the mobile phone camera as the device underwent a tilting motion that a user (in this case, the author) felt represented by a clear command action. The optic flow in these clips was dominated by translation of known magnitude and direction, thus a mean error, in pixels per frame, could be calculated. In total the algorithm was tested against 150 frames with an average translation of 8.13 pixels per frame (equivalent to the device having angular velocity of 21° per second). Thus, the algorithm was tuned to recognise that action of a user, rather than the user being forced to adapt to a fixed interface. The efficiency of the algorithm was tested by measuring the time taken to calculate optic flow per frame on the target device.

The large size of orthogonal filter, and the relatively large translations between frames, suggests that significant improvements in efficiency could be gained by decreasing the resolution of both the filter and arrays used to calculate correlations. Instead of taking the value of every pixel when filtering the image, only every f^{th} is taken. And instead of calculating the value of every pixel (and corresponding correlation) along the x and y arrays, only every a^{th} is taken. The effect on computation time and accuracy of array and filter resolution are summarised in Table 1 and FIG. 10. (Note that an error of 1 pixel per frame corresponds to a rate of 11%).

It is clear that for this particular application the resolution of both the correlation array and filters can be lowered to give an increase in efficiency with little reduction in accuracy. In particular, an array and filter resolution of a=3 and f=4 gives a performance of 11 frames per second (over twice the base rate) while the error rate only increases from 0.9 to 1.1 pixels per frame.

User Evaluation

Whether or not the performance of this algorithm is satisfactory for the purpose of controlling a user interface was tested by two simple tasks. In the first, the tilt interface was used in place of the cursor arrow keys: the user was presented with a series of polar directions (up, down, left, right) and had to tilt the device in the desired direction. Once a movement of the device was registered then the next direction was presented to the user. Both the accuracy and average time per “click” were recorded for a total of 100 clicks per user. As a control, the task was also repeated using the arrow keys of the phone d-pad, and also on a desktop computer using the cursor keys on a standard keyboard.

TABLE 1
Efficiency (in ms per frame) and error (in pixels per
frame) for varying array and filter resolutions

| Array Solution | Filter Resolution | Efficiency | Error |
|---|---|---|---|
| 1 | 1 | 202 | 0.901 |
| 1 | 2 | 158 | 0.912 |
| 1 | 3 | 147 | 0.978 |
| 1 | 4 | 139 | 1.040 |
| 2 | 1 | 139 | 0.956 |
| 2 | 2 | 135 | 0.981 |
| 2 | 3 | 130 | 1.031 |
| 2 | 4 | 127 | 1.102 |
| 3 | 1 | 130 | 0.992 |
| 3 | 2 | 115 | 1.087 |
| 3 | 3 | 95 | 1.094 |
| 3 | 4 | 90 | 1.107 |
| 4 | 1 | 95 | 1.343 |
| 4 | 2 | 92 | 1.367 |
| 4 | 3 | 89 | 1.432 |
| 4 | 4 | 89 | 1.545 |

TABLE 2
Error rate (in percentage of clicks in the wrong direction) and speed
of operation (in clicks per second) for the repetition task.

| | Error | Speed of Operation |
|---|---|---|
| Phone: tilt interface | 4 | 2.55 |
| Phone: d-pad | 1.3 | 2.35 |
| Desktop: cursor keys | 0.4 | 3.95 |

The second task was a proportional control task, in which the user was asked to follow a randomly moving circular target. The target had a radius of 25 pixels per second. (The screen resolution of the Nokia 7610 is 176×144 pixels) . As a control the task was also repeated using the arrow keys of the phone d-pad, and on a desktop computer using a standard mouse. The proportion of time that the pointer strayed from the target over a 1 minute period was recorded.

5 users were recruited for each task and were given a ten minute practice session with the interface. The results are given in table 2 and table 3.

TABLE 3
Error (in % of time off-target) for the target pursuit task

| | Error |
|---|---|
| Phone: tilt interface | 11.1% |
| Phone: d-pad | 14.2% |
| Desktop: mouse | 3.7% |

Although N is low in this case, the results give a qualitative indication of the potential of the interface. In the case of the direction-click task the error rate using the tilt interface is significantly higher than using either of the standard button-based interfaces, though the rate of response was comparable to that of the standard phone interface. Observation suggests that a significant source of error in registering a directional click was the tendency of users to “skew” the phone in a non-polar direction, rather than make a “clean” tilt.

For the target pursuit task, the error rate was similar to that of the standard phone keys but worse than that for the mouse interface. It should be noted that none of the users recruited for this task were teenagers or expert phone users and reported problems with the small size of the Nokia 7610 d-pad, particularly when required to give fast repeated clicks when following a moving target. This may partially explain the (relatively) poor performance of the d-pad interface compared to an ostensibly less reliable tilt interface.

Taken together, these results suggest that this optical flow algorithm is efficient enough to support a tilting vision-based interface. However, the high error rate on the repetition task may preclude it from being used as a straight replacement for cursor keys in applications, such as business or productivity applications, where accurate discrete cursor control is essential. The results on the target pursuit task suggest that the interface would be more suited to games or other applications where proportional-controlled movement is required, and where continuous feedback on the effect of users' input is available.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A hand-held device, comprising:
a computing application of the hand-held device which responds to directional commands of a user;
an image registering unit to register a series of images;
an image processing unit to derive motion data from the series of images corresponding to translational and/or rotational movement of the hand-held device in free space; and
a direction control unit to convert the motion data into a directional command and to supply the directional command to the computing application.

2. The hand-held device of claim 1, wherein the image registering unit is a camera fixedly carried by the hand-held device.

3. The hand-held device of claim 1, comprising a radio frequency communication unit, and an aerial for wireless communication with other devices.

4. The hand-held device of claim 3, wherein the communication unit performs wireless communication in a cellular telecommunications network.

5. The hand-held device of claim 1, wherein the hand-held device is a mobile telephone.

6. The hand-held device of claim 1, further comprising:
a display screen to provide a graphical user interface; and
wherein the computing application controls the graphical user interface of the display screen in response to the directional command of the direction control unit.

7. The hand-held device of claim 1, further comprising:
an audio output unit; and
wherein the computing application controls an audio signal of the audio output in response to the direction command of the direction control unit.

8. The hand-held device of claim 1, wherein the computing application controls an internal function of the hand-held device in response to the direction command of the direction control unit.

9. The hand-held device of claim 1, wherein the movement data represents a lateral X or Y transition of the hand-held device.

10. The hand-held device of claim 1, wherein the motion data represents a Z transition of the device toward or away from a background object.

11. The hand-held device of claim 1, wherein the motion data represents roll, pitch or yaw rotations of the device.

12. The hand-held device of claim 1, wherein the image processing unit derives the motion data by performing a motion detection algorithm on the image data.

13. The hand-held device of claim 1, wherein the image registering unit provides image data representing at least first and second images, and the image processing unit estimates an optic flow vector from the at least first and second images.

14. The hand-held device of claim 13, wherein image processing unit collates the first and second images by searching along a linear search path to determine motion data of a first direction, and searching along a second linear path to determine motion data of a second direction.

15. The hand-held device of claim 14, wherein the image processing unit searches along a linear array of light intensity detectors.

16. The hand-held device of claim 15, wherein the light intensity detectors each comprise a pixel in a row or column of 2D image data.

17. The hand-held device of claim 16, wherein the image processing unit smoothes the image data perpendicular to a major axis of the linear array.

18. The hand-held device of claim 17, wherein the smoothing is Gaussian smoothing.

19. The hand-held device of claim 15, wherein the image processing unit searches first or second derivatives of absolute light intensity values.

20. The hand-held device of claim 14, wherein the image processing unit searches each of a plurality of arrays located within a 2D image field to obtain movement data in two or more directions.

21. The hand-held device of claim 20, in which independent estimations of movement in each of a plurality of colour channels are combined.

22. A method of controlling a hand-held device, comprising:
registering a series of images taken from the hand-held device;
deriving motion data from the series of images corresponding to translational or rotational movement of the hand-held device in free space; and
converting the motion data into a direction command to control a computing application of the hand-held device.

23. The method of claim 22, in which the direction command is a command to scroll across an image on a display of the hand-held device, and/or a command to zoom in to and out of the image.

24. A computer readable storage medium having computer executable instructions stored thereon to cause a hand-held device to perform the method of claim 22.

25-26. (canceled)
